(19) United States
(12) Patent Application Publication
(10) Pub. No.: US 2025/0054938 A1
(43) Pub. Date: Feb. 13, 2025

(54) MANUFACTURING METHOD OF ELECTRODE, ELECTRODE, AND BATTERY

(71) Applicant: TOYOTA JIDOSHA KABUSHIKI KAISHA, Toyota-shi (JP)

(72) Inventors: Masashi UEDA, Toyota-shi (JP); Shinji KOJIMA, Nagoya-shi (JP); Tomoko HIGO, Toyota-shi (JP)

(73) Assignee: TOYOTA JIDOSHA KABUSHIKI KAISHA, Toyota-shi (JP)

(21) Appl. No.: 18/636,594

(22) Filed: Apr. 16, 2024

(30) Foreign Application Priority Data
Aug. 9, 2023 (JP) 2023-130508

(51) Int. Cl. H01M 4/04; H01M 4/13; H01M 4/139; H01M 4/36; H01M 4/62

(52) U.S. Cl. CPC H01M 4/0409; H01M 4/0404; H01M 4/13; H01M 4/139; H01M 4/366; H01M 4/623

(57) ABSTRACT

A method of fabricating an electrode includes: fabricating a first electrode layer disposed on a current collector; and fabricating a second electrode layer disposed on the first electrode layer. The first electrode layer is formed by electrostatic deposition, wet deposition, or rolled film formation. The second electrode layer is formed by rolled film formation. When the first electrode layer is fabricated by rolled film formation, at least part of a surface of active material particles used in the rolled film formation is coated with a resin that is different from polytetrafluoroethylene.

### CROSS-REFERENCE TO RELATED APPLICATION

This application claims priority to Japanese Patent Application No. 2023-130508 filed on Aug. 9, 2023, incorporated herein by reference in its entirety.

### BACKGROUND

### 1. Technical Field

The present disclosure relates to a manufacturing method of an electrode, the electrode, and a battery.

### 2. Description of Related Art

In a battery such as a lithium-ion secondary battery, an electrode is used in a state in which active material particles are fixed to a surface of a current collector, such as a metal foil or the like, by a binder.

Known manufacturing methods of electrodes include a method of applying a composition prepared by mixing active material particles and a binder with a solvent to a surface of a current collector (also referred to as wet method) and a method of fixing active material particles to a current collector by a binder without using a solvent (also referred to as dry method).

As a manufacturing method of an electrode according to the dry method, a method of using a resin that has a property of exhibiting fibrillation when a shear force is applied, as a binder, has been proposed. For example, Japanese Unexamined Patent Application Publication No. 2022-3694 (JP 2022-3694 A) describes a method in which polytetrafluoroethylene (PTFE) in a mixture containing active material particles and PTFE is subjected to fibrillation to fabricate an electrode film, and thereafter the electrode film is integrated with a current collector, thereby manufacturing an electrode.

### SUMMARY

The electrode obtained by the method described in JP 2022-3694 A has high interfacial resistance at an interface between an electrode layer and the current collector, and there is room for improvement in electron conductivity.

An object of an embodiment of the present disclosure is to provide a manufacturing method of an electrode having excellent electron conductivity, the electrode having excellent electron conductivity, and a battery including the electrode having excellent electron conductivity.

Means for solving the above problem includes the following embodiments.
1. A manufacturing method of an electrode includes
fabricating a first electrode layer disposed on a current collector, and
fabricating a second electrode layer disposed on the first electrode layer.

The first electrode layer is fabricated by electrostatic film formation, wet film formation, or rolled film formation.

The second electrode layer is fabricated by rolled film formation.

When the first electrode layer is fabricated by rolled film formation, at least part of a surface of active material particles used in the rolled film formation is coated with a resin that is different from polytetrafluoroethylene.
2. The manufacturing method according to 1, in which the rolled film formation includes fibrillation of polytetrafluoroethylene in a mixture containing active material particles and polytetrafluoroethylene.
3. The manufacturing method according to 1, in which the resin different from the polytetrafluoroethylene is polyvinylidene fluoride.
4. An electrode includes
a current collector, a first electrode layer disposed on the current collector, and a second electrode layer disposed on the first electrode layer.

The first electrode layer contains active material particles and a resin with a polytetrafluoroethylene content of 0% by mass or more and less than 5% by mass, or contains active material particles of which at least part of a surface is coated with a resin different from PTFE, and fibrous PTFE.

The second electrode layer includes active material particles and fibrous PTFE.
5. A battery includes the electrode according to 4.

According to an embodiment of the present disclosure, a manufacturing method of an electrode having excellent electron conductivity, the electrode having excellent electron conductivity, and a battery including the electrode having excellent electron conductivity, are provided.

### DETAILED DESCRIPTION OF EMBODIMENTS

In the present disclosure, a numerical range indicated by using “-” means a range including numerical values before and after “-” as a minimum value and a maximum value, respectively.

In the numerical range described in the present disclosure in a stepwise manner, the upper limit value or the lower limit value described in a certain numerical range may be replaced with the upper limit value or the lower limit value of the numerical range described in another stepwise manner. In the numerical ranges described in the present disclosure, the upper limit value or the lower limit value described in a certain numerical range may be replaced with the value shown in the examples.

In the present disclosure, the term “step” is included in the term as long as the intended purpose of the step is achieved, even if it is not clearly distinguishable from other steps as well as independent steps.

In the present disclosure, a combination of two or more preferred embodiments is a more preferred embodiment.

In the present disclosure, the amount of each component means the total amount of a plurality of substances unless otherwise specified, when a plurality of substances corresponding to each component are present.

An electrode manufacturing method comprising:

A method of manufacturing an electrode of the present disclosure includes:
fabricating a first electrode layer disposed on a current collector, and
fabricating a second electrode layer disposed on the first electrode layer.

The first electrode layer is fabricated by electrostatic film formation, wet film formation, or rolled film formation.

The second electrode layer is fabricated by rolled film formation.

When the first electrode layer is fabricated by rolled film formation, at least part of a surface of active material particles used in the rolled film formation is coated with a resin that is different from polytetrafluoroethylene.

The method of manufacturing an electrode of the present disclosure includes a step of forming a first electrode layer disposed on a current collector, and a step of forming a second electrode layer disposed on the first electrode layer. That is, the electrode manufactured by the method of the present disclosure has a structure in which a current collector, a first electrode, and a second electrode are arranged in this order.

As shown in Examples to be described later, when the electrode layer disposed on the current collector is formed by rolled film formation, the interface resistance at the interface between the electrode layer and the current collector tends to be high. The reason for this is considered to be that the adhesion force of PTFE contained as a binder to the current collector is lower in the electrode layers produced by the rolled film formation. In the electrode manufactured by the method of the present disclosure, the first electrode is disposed between the current collector and the second electrode layer formed by the rolled film formation. The first electrode layer is formed by electrostatic film formation, wet film formation, or rolled film formation, and the active material particles used in the rolled film formation are at least partially coated with a resin that differs from PTFE. Therefore, the first electrode layer exhibits sufficient adhesion to the current collector. As a result, the interface resistance at the interface between the electrode and the current collector can be reduced, and good electron conductivity can be achieved.

Hereinafter, the step of fabricating the first electrode is also referred to as “step 1”, and the step of fabricating the second electrode layer is also referred to as “step 2”.

### Process 1

In step 1, a first electrode is fabricated that is disposed on a current collector. The method of manufacturing the first electrode is electrostatic film formation, wet film formation, or rolled film formation. If the way to produce the first electrode is a rolled film formation, at least a portion of the surface of the active material particles used in the rolled film formation is coated with a resin which differs from PTFE.

In the present disclosure, “electrostatic deposition” means a method of forming an electrode layer by electrostatically attaching a material of the electrode layer to a current collector.

In the present disclosure, “wet film formation” means a method of forming an electrode layer by applying a composition obtained by adding a solvent to a material of an electrode layer to a current collector.

As used herein, the term “rolled film formation” refers to a process for forming a sheet-like molded article by subjecting a material of an electrode layer containing a PTFE to a rolling process for fibrillation in PTFE. The electrode layer formed by the rolled film formation is not formed on the current collector, but is formed as a self-supporting film. The rolling process can be performed using a roll press machine or the like.

Among the above methods, the electrostatic film formation and the rolled film formation are classified into a dry method that does not use a solvent. Therefore, in the case where the first electrode layer is formed by electrostatic film formation or rolled film formation, the first electrode layer is advantageous in terms of reducing the manufacturing cost of the electrode, reducing the influence on the environment and the living body, and the like.

The material used to fabricate the first electrode includes, for example, active material particles and a binder, and further includes, if necessary, a conductive material.

The type of the active material particles is not particularly limited, and may be selected from materials commonly used in the production of electrodes. The active material particles May be positive electrode active material particles or negative electrode active material particles.

Examples of the positive electrode active material include a lithium transition metal composite oxide. Examples of the transition metal include Ni, Co, Mn, Al, B, Mg, Ti, V, Cr, Fe, Cu, Zn, Ga, Sr, Zr, Nb, In, Sn, Ta, and W. Among them, a lithium transition metal composite oxide containing at least one selected from Ni, Co and Mn is preferable, and a lithium transition metal composite oxide containing Ni, Co and Mn (NCM, nickel cobalt manganese oxide) is more preferable.

Specifically, the lithium transition metal composite oxide includes lithium cobaltate (LiCoO₂), lithium nickelate (LiNiO₂), lithium manganate (LiMnO₂), these duplicates (LiCoₓNi_{y}Mn_{z}O₂, x+y+z=1), double oxides including additive elements M′ (LiCoₐNi_{b}Mn_{c}M′_{d}O₂, a+b+c+d=1, M′: Al, Mg, Ti, Zr or Ge), spinel-type lithium manganese oxides (LiMn₂O₄), and olivine-type LiMPO₄ (M: Co, Ni, Mn, Fe).

The positive electrode active material used in the preparation of the electrode layer may be one kind alone or two or more kinds thereof.

The volume average particle diameter of the positive electrode active material particles is not particularly limited, and can be selected, for example, from the range of 5 μm-30 μm.

Specific examples of the negative electrode active material include carbon materials such as graphite, soft carbon, and hard carbon, and silicon.

The negative electrode active material used in the production of the electrode layer may be one kind alone or two or more kinds thereof.

The volume average particle diameter of the negative electrode active material particles is not particularly limited, and can be selected from, for example, a range of 5 μm-30 μm.

The volume-average particle size of the particles is a D50 when the cumulative particle size from the smaller diameter side is 50% in the volume-based particle size distribution measured by the laser diffractometry and scattering method.

The type of the binder is not particularly limited, and may be selected from materials commonly used in the manufacture of electrodes.

Examples of the binder for producing the first electrode layer by electrostatic film formation or wet film formation include polyvinylidene fluoride, polyethylene, polypropylene, polyethylene terephthalate, cellulose, nitrocellulose, carboxymethylcellulose, polyethylene oxide, polyepichlorohydrin, polyacrylonitrile, styrene-butadiene rubber (SBR), acrylonitrile-butadiene rubber (NBR), polyacrylate, and polymethacrylate.

The binder used for producing the first electrode layer may be one kind alone or two or more kinds thereof. The binder is preferably polyvinylidene fluoride (PVdF) from the viewpoint of adhesion strength, affinity with PTFE contained in the second electrode layers, electrolyte resistance, and the like.

From the viewpoint of adhesion to the current collector, it is preferable that the binder does not contain PTFE or the content of PTFE is less than 5 wt %.

PTFE is an example of a binder for forming the first electrode layers by rolled film formation. PTFE may be subjected to fibrillation by a rolling process to bind the active material grains and form a sheet-like molded article. PTFE may be particulate.

The binder used for forming the first electrode layer by rolled film formation may be PTFE alone, or may be a blend of PTFE and PTFE.

When the binder in the case of forming the first electrode layer by rolled film formation is a mixture of PTFE and a resin different from PTFE, the content of the resin different from PTFE in the mixture may be 20 parts by mass or less, 10 parts by mass or less, or 5% by mass or less based on parts by mass of PTFE100.

The type of the conductive material is not particularly limited, and may be selected from materials commonly used in the manufacture of electrodes.

Specific examples of the conductive material include carbon black (acetylene black, thermal black, furnace black, and the like), carbon nanotubes, and carbon materials such as graphite. The conductive material used in the production of the electrode may be one kind alone or two or more kinds thereof.

The amount of the binder with respect to 100 parts by mass of the active material particles in the material of the first electrode layer may be selected from the range of, for example, 0.1 parts by weight-10 parts by weight, or 1 part by weight-5 parts by weight.

The amount of the conductive material relative to 100 parts by mass of the active material particles in the material of the first electrode layer may be selected from the range of, for example, 0.1 parts by weight-10 parts by weight, or 1 part by weight-5 parts by weight.

When the material of the first electrode layer includes the active material particles and the conductive material, a composite treatment for fixing the conductive material to the surface of the active material particles may be performed.

The method for carrying out the composite treatment is not particularly limited, and can be carried out by a known method.

For example, a method of imparting a shearing force to a mixture of active material particles and a conductive material is exemplified.

The compounding treatment may be performed in a state in which the mixture of the active material particles and the conductive material contains a binder, or in a state in which the mixture of the active material particles and the conductive material does not contain a binder. From the viewpoint of suppressing the separation between the active material particles and the conductive material, the compounding treatment is preferably performed in a state in which the mixture of the active material particles and the conductive material contains a binder.

When the first electrode layer is formed by rolled film formation, at least a part of the surface of the active material particles used for rolled film formation is coated with a resin that differs from PTFE. The type of the resin coating the surface of the active material particles is not particularly limited, and can be selected from known materials. For example, it may be selected from the binders described above.

From the viewpoint of adhesion strength, compatibility with PTFE contained in the first electrode layers, electrolyte resistance, and the like, polyvinylidene fluoride (PVdF) is preferable as a resin for coating the active material particles.

The method of coating the surface of the active material particles with the resin is not particularly limited, and can be carried out by a known method. For example, the surface of the active material particles may be coated with a binder (i.e., resin) used to fix the conductive material to the surface of the active material particles by the above-described compounding treatment.

From the viewpoint of ensuring sufficient adhesion to the current collector, the coating ratio of the surface of the active material particles by the resin is preferably 3% or more, more preferably 5% or more, and still more preferably 10% or more.

The coverage of the surface of the carbon particles by the resin may be 60% or less, 50% or less, or 40% or less.

The coverage of the surface of the carbon particles by the resin is measured by an image analysis method.

Examples of the image-analysis method include a method in which F-mapping is performed by energy-dispersive X-ray spectroscopy (EDX). Specifically, the resin-coated carbon-particles are observed by scanning electron microscopy (SEM) and F-mapped by EDX. The region X corresponding to the carbon particles and the region Y of the region X in which the resin (F) is present are binarized, and the coverage ratio is calculated by the following formula.

$$Coverage ( \% ) = ( area of Y area / X ) \times 100.$$

The thickness of the first electrode formed in step 1 is not particularly limited. For example, the thickness of the first electrode can be selected from the range of 10 μm-200 μm.

The material of the current collector used in step 1 is not particularly limited, and may be selected from known materials such as aluminum, copper, nickel, titanium, and stainless steel.

### Step 2

In step 2, a second electrode layer disposed on the first electrode layer is fabricated. A method of manufacturing the second electrode is rolled film formation.

The method for producing the second electrode by rolled film formation is the same as the method for producing the first electrode by rolled film formation described above.

Unlike the first electrode layer, the second electrode layer is not in contact with the current collector. For this reason, at least a part of the active material grains may not be coated with a resin which differs from PTFE as in the case where the first electrode is formed by rolled film formation.

The material used for manufacturing the second electrode is the same as the material used for manufacturing the first electrode described above.

The amount of the binder with respect to 100 parts by mass of the active material particles in the material of the second electrode layer may be selected from the range of, for example, 0.1 parts by weight-10 parts by weight, or 1 part by weight-5 parts by weight.

The amount of the conductive material relative to 100 parts by mass of the active material particles in the material of the second electrode layer may be selected from the range of, for example, 0.1 parts by weight-10 parts by weight, or 1 part by weight-5 parts by weight.

The thickness of the second electrode produced in step 2 is not particularly limited. For example, the thickness of the second electrode can be selected from the range of 10 μm-200 μm.

In the method of the present disclosure, the method of integrating the electrode layer and the current collector produced by the rolled film formation is not particularly limited, and can be performed using a roll press machine, a flat press machine, or the like.

When the first electrode layer is formed by electrostatic film formation or wet film formation, the current collector in a state where the first electrode layer is formed on the surface and the second electrode layer are integrated.

When the first electrode layer is formed by rolled film formation, the current collector, the first electrode layer, and the second electrode layer are integrated. From the viewpoint of working efficiency, it is preferable that the current collector, the first electrode layer, and the second electrode layer are integrated at the same time.

### Electrode

Electrodes of the present disclosure include:
a current collector, a first electrode layer disposed on the current collector, and a second electrode layer disposed on the first electrode layer.

The first electrode layer includes active material particles and a resin having a PTFE content of 0% by mass or more and less than 5% by mass, or includes active material particles and a fibrous PTFE in which at least a part of the surface is coated with a resin that differs from PTFE.

The second electrode layer includes active material particles and fibrous PTFE.

In the electrode, the current collector and the second electrode including the active material grains and the fibrous PTFE are not in contact with each other. A first electrode layer is disposed between the current collector and the second electrode.

The first electrode layer includes active material particles and a resin having a PTFE content of 0% by mass or more and less than 5% by mass, or includes active material particles and a fibrous PTFE in which at least a part of the surface is coated with a resin that differs from PTFE. Therefore, the first electrode layer exhibits sufficient adhesion to the current collector. Therefore, the electrode of the present disclosure has a sufficiently low interfacial resistance at the interface between the current collector and the electrode layer, and exhibits excellent electron conductivity.

The details and preferred aspects of each material included in the electrodes and electrodes of the present disclosure are the same as the details and preferred aspects of the electrodes and each material used in the above-described method for manufacturing an electrode.

In the first electrode layer, the amount of the resin relative to 100 parts by mass of the active material particles may be selected from the range of, for example, 0.1 parts by weight-10 parts by weight, or 1 part by weight-5 parts by weight.

When the first electrode layer includes a conductive material, the amount of the conductive material with respect to 100 parts by mass of the active material particles may be selected from the range of, for example, 0.1 parts by weight-10 parts by weight, or 1 part by weight-5 parts by weight.

In the second electrode layer, the amount of PTFE relative to 100 parts by mass of the active material particles may be selected from the range of, for example, 0.1 parts by weight-10 parts by weight, or 1 part by weight-5 parts by weight.

When the second electrode layer includes a conductive material, the amount of the conductive material with respect to 100 parts by mass of the active material particles may be selected from the range of, for example, 0.1 part by weight-10 parts by weight, or 1 part by weight-5 parts by weight.

### Battery

The battery of the present disclosure includes the electrode of the present disclosure described above.

The battery of the present disclosure includes the electrode of the present disclosure as at least one of a positive electrode and a negative electrode, and in some embodiments, includes the electrode of the present disclosure as a positive electrode.

The type of battery of this disclosure is not specifically restricted and can be selected from: lithium ion secondary battery (including liquid system battery and total solid cell), lead battery, nickel/hydrogen battery, nickel/cadmium battery, nickel/iron battery, nickel/zinc battery, silver/zinc oxide battery, cobalt titanium secondary battery, sodium ion secondary battery, etc.

Hereinafter, the present disclosure will be described in more detail with reference to Examples, but the disclosure of the present disclosure is not limited to these Examples.

### Example 1

The following ingredients were put into a MP mixer (Nippon Coke Industries Co., Ltd.) and subjected to a compounding treatment under a 10000 rpm of 10 minutes. When the active material grains after the compounding treatment were observed by SEM, the conductive material was fixed to the surface and the surface was coated with PVdF. Active material particles: NCM (volume-average particle diameter: 10 μm, 96.6 parts by mass)
Conductive material: acetylene black (1.5 parts by mass)
Binder: PVdF (1.6 parts by mass)

A layer containing active material particles after the composite treatment was formed on an aluminum foil (thickness: 12 μm) as a current collector using an electrostatic screen film forming apparatus (Belk Industries, Ltd.) to obtain a laminate. The film formation conditions were 1.5 kV, and the distance between the current collector and the screen was 1 cm.

The laminate was subjected to a 5 t load for 1 minute on two plates heated to 180° C. As a result, the binder in the layer containing the active material particles was softened or melted, and the active material particles were fixed to the current collector, so that the first electrode layer was formed on the current collector.

The following ingredients were introduced into a MP mixer (Nippon Coke Industries Co., Ltd.) and mixed at a 300 rpm of 180 seconds. A portion of PTFE particles were then subjected to fibrillation and further mixed at a 5000 rpm of 500 seconds to form a granulated material with the active material particles bound in the fibrillated PTFE.
Active material particles: NCM (volume-average particle diameter: 10 μm, 96.5 parts by mass)
Conductive material: acetylene black (1.5 parts by mass)
Binder: PTFE (2.0 parts by mass)

The mixture containing the granulate is rolled in a roll press (linear rolling: 0.4 t/cm), and PTFE was subjected to fibrillation and formed into a sheet-like shape (thickness: 120 μm) to prepare a second electrode layer as a free-standing film. The obtained second electrode layer and the surface of the aluminum foil on the side on which the first electrode layer was formed were bonded together by a roll press (linear pressure: 0.4 t/cm, 160° C.).

Through the above steps, an electrode in a state in which a first electrode layer formed by electrostatic film formation and a second electrode layer formed by rolled film formation were disposed on a current collector was obtained.

### Example 2

The following ingredients were put into a MP mixer (Nippon Coke Industries Co., Ltd.) and subjected to a compounding treatment under a 10000 rpm of 10 minutes. The amounts of PVdF and PTFE were set such that the total volume was equal to the total volume of the binder used in Example 1.
Active material particles: NCM (volume-average particle diameter: 10 μm, 96.6 parts by mass)
Conductive material: acetylene black (1.5 parts by mass)
Binder: PVdF (0.5 parts by mass)

PTFE (1.4 parts by mass) was further added to MP mixer after complexation, and mixed at a 300 rpm of 180 seconds. The mixture was then further mixed at a 5000 rpm of 500 seconds so as to form a granulate in which the active material particles were bound in a fibrillated PTFE.

The mixture containing the granulate is rolled in a roll press (linear rolling: 0.4 t/cm), PTFE was fibrillated and formed into a sheet-like shape (thickness: 120 μm) to prepare a first electrode layer as a free-standing film.

An aluminum foil (thickness: 12 μm) as a current collector, a first electrode layer, and a second electrode layer prepared in the same manner as the second electrode layer of Example 1 were bonded to each other by a roll press (linear pressure: 0.4 t/cm, 160° C.).

Through the above steps, a positive electrode was obtained in a state in which the first electrode layer formed by electrostatic film formation and the second electrode layer formed by rolled film formation were disposed on a current collector.

### Comparative Example 1

An aluminum foil (thickness: 12 μm) as a current collector, a first electrode layer prepared in the same manner as the second electrode layer of Example 1, and a second electrode layer prepared in the same manner as the second electrode layer of Example 1 were bonded together by a roll press (linear pressure: 0.4 t/cm, 160° C.).

Through the above steps, a positive electrode was obtained in a state in which the first electrode layer formed by the rolled film formation and the second electrode layer formed by the rolled film formation were disposed on the current collector.

### Evaluation of Electronic Conductivity

As an index of the electronic conductivity of the electrodes prepared in Examples and Comparative Examples, the resistance (interfacial resistance) at the interface between the first electrode layer and the current collector was measured using an electrode resistance measuring system RM2610 (Nikki Electric Co., Ltd.). The results are shown in Table 1.

TABLE 1

| | First | Second | Interfacial |
|---|---|---|---|
| | electrode | electrode | resistance |
| | layer | layer | [Ω · cm²] |
| Comparative | rolled film | rolled | 1.0 |
| Example 1 | formation (without | film | |
| | PVdF film) | formation | |
| Example 1 | Electrostatic | rolled film | 0.5 |
| | deposition | formation | |
| Example 2 | rolled film | rolled film | 0.8 |
| | formation (with | formation | |
| | PVdF film) | | |

As shown in Table 1, the positive electrode of Example 1 in which (i) the first electrode layer is formed by electrostatic film formation, and the positive electrode of Example 2 in which (ii) the first electrode layer is formed by rolled film formation and the active material grains contained in the first electrode layer are coated with PVdF have lower interfacial resistivity at the interface between the first electrode layer and the current collector than the positive electrode of Comparative Example 1. In the positive electrode of Comparative Example 1, the 1 electrode layer is formed by rolled film formation, and the active material particles contained in the 1 electrode layer are not coated with PVdF The above results are considered to be because the first electrode produced in Example 1 and Example 2 has better adhesion to the current collector than the first electrode produced in Comparative Example 1.

What is claimed is:

1. A manufacturing method of an electrode, the manufacturing method comprising:
fabricating a first electrode layer disposed on a current collector; and
fabricating a second electrode layer disposed on the first electrode layer, wherein
the first electrode layer is fabricated by electrostatic film formation, wet film formation, or rolled film formation,
the second electrode layer is fabricated by rolled film formation, and
when the first electrode layer is fabricated by rolled film formation, at least part of a surface of active material particles used in the rolled film formation is coated with a resin that is different from polytetrafluoroethylene.

2. The manufacturing method according to claim 1, wherein the rolled film formation includes fibrillation of polytetrafluoroethylene in a mixture containing active material particles and polytetrafluoroethylene.

3. The manufacturing method according to claim 1, wherein the resin different from polytetrafluoroethylene is polyvinylidene fluoride.

4. An electrode, comprising:
a current collector;
a first electrode layer disposed on the current collector; and
a second electrode layer disposed on the first electrode layer, wherein
the first electrode layer contains active material particles and a resin having a polytetrafluoroethylene content of 0% by mass or more and less than 5% by mass, or contains active material particles of which at least part of a surface is coated with a resin different from PTFE, and fibrous PTFE, and
the second electrode layer includes active material particles and fibrous PTFE.

5. A battery, comprising the electrode according to claim 4.
